(19) United States
(12) Patent Application Publication
(10) Pub. No.: US 2026/0179045 A1
(43) Pub. Date: Jun. 25, 2026

(54) A SYSTEM FOR PROVIDING A NETWORKING PLATFORM FOR USER INTERACTION AND A METHOD THEREOF

(71) Applicants: Kshitij Prasad TIWARI, Hyderabad (IN); Alamelu KRISHNAMOORTHY, Hyderabad (IN)

(72) Inventors: Kshitij Prasad TIWARI, Hyderabad (IN); Alamelu KRISHNAMOORTHY, Hyderabad (IN)

(21) Appl. No.: 18/836,743

(22) PCT Filed: Jul. 8, 2024
(86) PCT No.: PCT/IB2024/056647

§ 371 Date: Aug. 7, 2024

(30) Foreign Application Priority Data
Jul. 22, 2023 (IN) 202341036584

(51) Int. Cl. G06Q 10/101; G06Q 10/42

(52) U.S. Cl. CPC G06Q 10/101; G06Q 10/42

(57) ABSTRACT

The present invention relates to a system (100) and a method (300) for providing a networking platform for B2B interaction between one or more users. The system (100) integrates a processor (201) and a memory (202) that stores instructions to execute various tasks. The system (100) receives various types of content from the one or more users. Further, the system (100) analyzes one or more user profiles associated with the one or more users to determine the relevancy of the received content based on a user input. By identifying one or more relevant profiles, the platform ensures that content is shared with appropriate users, fostering collaboration and co-creation. The co-created content is then provided to the one or more relevant users, enhancing engagement and knowledge sharing. Overall, the system (100) enables efficient and personalized content delivery, enhancing effective collaboration and co-creation of ideas, product and innovation.

### TECHNICAL FIELD

The present subject matter described herein, in general, relates to a digital platform for connecting all stakeholders involved in a business value chain including suppliers, manufacturers, experts, service providers and customers. The platform offers various features, such as content posting, content consumption, stakeholder connection, community formation with like-minded individuals, and live sessions attendance, among others. More particularly, the present subject matter relates to a networking platform for B2B interaction between one or more users by empowering effective collaboration and co-creation of ideas, product and innovation.

### BACKGROUND

This section is intended to introduce the reader to various aspects of art (the relevant technical field or area of knowledge to which the invention pertains), which may be related to various aspects of the present disclosure that are described or claimed below. This discussion is believed to be helpful in providing the reader with background information to facilitate a better understanding of the various aspects of the present disclosure. Accordingly, it should be understood that these statements in this background section are to be read in this light, and not as admissions of prior art. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

The conventional digital platforms typically offer limited features and functionalities that are mostly designed for content sharing and consumption. These platforms often lack the tools and services that enable effective collaboration, communication, and co-creation among stakeholders. As a result, the stakeholders involved in a business value chain may face challenges in terms of information sharing, coordination, and innovation.

Furthermore, the conventional digital platforms may not be specifically designed for professional purposes, and hence may not cater to the specific needs and requirements of stakeholders and other participants involved in a business value chain. There may also be limitations in terms of security, privacy, and data management, which can further hinder effective collaboration and value creation.

Furthermore, there is currently no platform that may provide a comprehensive solution to the problem at hand, which is to connect all stakeholders in a value chain (e.g. Suppliers, Vendors, Manufacturers, Experts etc.) and provide an ecosystem for them to interact and collaborate. Instead, stakeholders have to rely on conventional methods such as visiting exhibitions and trade shows, leveraging personal and social networks, which may not fully address their needs. However, these methods are only able to solve smaller problems and cannot provide a complete solution. In other words, the existing solutions only address the problem partially and are not sufficient to meet the needs of the users. There is no digital ecosystem for users, who can post/promote content, consume content, connect with different stakeholders, form communities with like-minded individuals, attend live sessions etc.

Conventional methods for connecting people through multiple avenues such as visiting exhibitions and trade shows may have limitations in terms of reach and scope. They may be typically limited to a particular location and timeframe and may not provide an opportunity for ongoing collaboration and interaction between stakeholders. Personal and social networks may also be limited in terms of scope and may not necessarily connect stakeholders with the most relevant and suitable partners. The lack of advanced profiling and content relevance matching mechanisms results in users receiving irrelevant content, reducing the efficiency and effectiveness of interactions.

Therefore, there is a need for the digital platform that provides a professional ecosystem for stakeholders involved in a business value chain, which enables effective collaboration, communication, and co-creation, and promotes innovation and growth. The proposed digital platform aims to address these issues and provides an integrated ecosystem that brings all stakeholders together to interact, brainstorm, co-create, promote, and showcase ideas, products, and innovations for a better future.

Further limitations and disadvantages of conventional and traditional approaches will become apparent to one of skill in the art, through the comparison of described systems with some aspects of the present disclosure, as set forth in the remainder of the present application and with reference to the drawings.

### SUMMARY

This summary is provided to introduce concepts related to a system and a method for providing a networking platform for B2B interaction between one or more users and the concepts are further described below in the detailed description. This summary is not intended to identify essential features of the claimed subject matter nor is it intended for use in determining or limiting the scope of the claimed subject matter.

According to embodiments illustrated herein, there is provided a system for providing a networking platform for B2B interaction between one or more users. In one implementation of the present disclosure, the system may involve a processor and a memory. The memory is communicatively coupled to the processor. Further, the memory stores processor executable instructions, which, on execution, may causes the processor to receive a content from the one or more users. In an embodiment, the content may correspond to at least one of a video, a knowledge sharing article, a presentation, a promotion, an advertisement, and an inquiry. Further, the processor may be configured to analyze one or more user profiles associated with the one or more users to identify relevance of the received content based on a user input. In an embodiment, the user input may be indicative of user intent, user preferences, and user interests. Further, the processor may be configured to identify one or more relevant profiles from the one or more user profiles, associated with one or more users, based on the analysis. Furthermore, the processor may be configured to share the received content with the one or more relevant profiles from the one or more users identified as one or more relevant users. Furthermore, the processor may be configured to enable collaboration on the shared content amongst the one or more relevant users for co-creating content. Moreover, the processor may be configured to provide the created content to the one or more relevant users corresponding to the one or more relevant profiles.

According to embodiments illustrated herein, there is provided a method for providing the networking platform for B2B interaction between the one or more users. In one implementation of the present disclosure, the method may involve various steps performed by the processor. The method may involve a step of receiving a user input indicative of user intent, user preference and user interest. The user input may be utilized to create one or more user profiles associated with one or more users. Further, the method may involve a step of receiving the content from the one or more users. In an embodiment, the content corresponds to at least one of the video, the knowledge sharing article, the presentation, the promotion, the advertisement, and the inquiry. Further, the method may involve a step of analyzing, the one or more user profiles associated with the one or more users to identify relevance of the received content based on the user input. In an embodiment, the user input is indicative of user intent, user preferences, and user interests. Further, the method may involve a step of identifying the one or more relevant profiles from the one or more user profiles, associated with one or more users, based on the analysis. Furthermore, the method may involve a step of sharing the received content with the one or more relevant profiles associated with the one or more users identified as the one or more relevant users. Furthermore, the method may involve a step of enabling collaboration on the shared content amongst the one or more relevant users for co-creating content. Moreover, the method may involve a step of providing the created content to the one or more relevant users corresponding to the one or more relevant profiles.

According to embodiments illustrated herein, there is provided a non-transitory computer-readable storage medium having stored thereon, a set of computer-executable instructions causing a computer comprising one or more processors to perform various steps. The steps may involve receiving a user input indicative of user intent, user preference and user interest. The user input may be utilized to create one or more user profiles associated with one or more users. Further, the steps may involve receiving the content from the one or more users. In an embodiment, the content corresponds to at least one of the video, the knowledge sharing article, the presentation, the promotion, the advertisement, and the inquiry. Further, the steps may involve analyzing, the one or more user profiles associated with the one or more users to identify relevance of the received content based on the user input. In an embodiment, the user input is indicative of user intent, user preferences, and user interests. Further, the steps may involve identifying the one or more relevant profiles from the one or more user profiles, associated with one or more users, based on the analysis. Furthermore, the steps may involve sharing the received content with the one or more relevant profiles associated with the one or more users identified as the one or more relevant users. Furthermore, the steps may involve enabling collaboration on the shared content amongst one or more relevant users for co-creating content. Moreover, the steps may involve providing the created content to one or more relevant users corresponding to the one or more relevant profiles.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram that illustrates a system (100) for providing a networking platform for B2B interaction between one or more users, in accordance with an embodiment of the present invention.

FIG. 2 is a block diagram (200) that illustrates various components of an application server configured for providing the networking platform for B2B interaction between one or more users, in accordance with an embodiment of the present invention.

FIG. 3 is a flowchart (300) that illustrates a method for providing a networking platform for B2B interaction between one or more users, in accordance with an embodiment of the present invention; and

FIG. 4 illustrates a block diagram (400) of an exemplary computer system for implementing embodiments consistent with the present disclosure.

### DETAILED DESCRIPTION

The present disclosure may be best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented, and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

The terminology “one or more users”, “users”, “user profiles”, and “stakeholders” has the same meaning and are used alternatively throughout the specification. The terminology “digital ecosystem”, “digital platform”, “networking platform”, and “platform” has the same meaning and are used alternatively throughout the specification. The terminology “B2B”, “Business to Business” has the same meaning and are used alternatively throughout the specification.

The present disclosure relates to a system for providing a networking platform for interaction between one or more users. The system is implemented by an electronic device including one or more processors and a memory communicatively coupled to a processor, and the memory is configured to store processor-executable instructions. Further, the system enables the processor to execute various tasks. Thes tasks may include receiving content from the one or more users. Further, the system may analyze one or more user profiles associated with the one or more users to determine the relevance of received content based on a user input. Further, the system may identify one or more relevant profiles from the one or more users and share the content with these one or more relevant users to foster targeted collaboration. Further, the system may enable the one or more relevant users to co-create content and subsequently provides this co-created content to the one or more relevant users. Additionally, a network interface facilitates communication between the system and external devices or networks, enhancing connectivity and interaction. The disclosed platform may aim to cultivate an interactive and dynamic digital ecosystem, ideal for connecting stakeholders across various domains, promoting efficient and effective collaboration, and driving innovation and value creation.

The objective of the present disclosure may be to provide a networking platform for empowering collaboration and co-creation among all stakeholders involved in a business value chain including suppliers, manufacturers, and customers. More specifically, the networking platform provides an improved system and a method for interaction between one or more users by empowering effective collaboration and co-creation of ideas, product and innovation. The disclosed networking platform provides a digital environment for its users, comprising diverse functionalities, such as content sharing, content consumption, stakeholder networking, and community building with individuals sharing similar interests.

Another objective of the present disclosure may be to provide an ecosystem of networking platform for idea, innovations and products where stakeholders, including suppliers, vendors, manufacturers, professional experts, employees, and others within B2B space can interact with each other. This platform may create a many-to-many linkage that may allow for meaningful discovery of networks leading to collaborations. Furthermore, this platform may enable manufacturers to reach out to all their stakeholders in one place and fosters interactions that may lead to the creation of new ideas, innovations, and products. The disclosed platform offers a higher level of connectivity and collaboration among stakeholders, to expand the reach to relevant stakeholders exponentially and reduce the time.

Yet another objective of the present disclosure may be to provide a networking platform for people with similar professional or business interests to interact, collaborate, and co-create products, ideas, and innovations. This may provide a space for discussion forums, group projects, and brainstorming sessions. This collaboration may occur within the same company or industry or even across different industries with common causes and interests. By bringing together individuals with complementary skills and knowledge, the disclosed platform fosters cooperation and the creation of innovative solutions to complex problems.

Yet another objective of the present invention may be to focus on showcasing ideas, products, and innovations to a targeted and relevant user. The disclosed platform may provide a space for manufacturers, innovators, and businesses to showcase their ideas, products, and innovations to a wide range of stakeholders, including suppliers, vendors, employees, and end customers. The disclosed platform may offer a tool for creating and sharing content, such as videos, articles, and presentations, and may also provide features for promoting and marketing products and services to the right audience.

Yet another objective of the present invention may be to eliminate the need for face-to-face meetings and physical travel, reducing both time and cost significantly. The platform may allow for instant communication and collaboration between stakeholders from different parts of the world, thereby creating opportunities for businesses to grow and for individuals to co-create a better future.

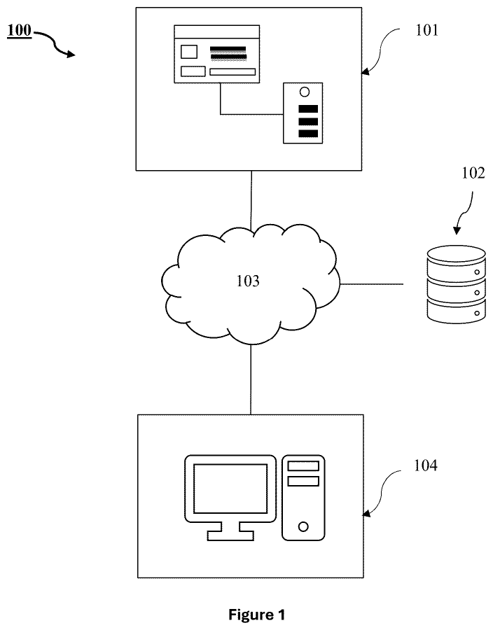

Now referring to FIG. 1, illustrates a block diagram describing a system (100) for providing the networking platform for B2B interaction between one or more users, in accordance with an embodiment of the present invention. The system (100) typically includes an application server (101), a database server (102), a communication network (103), and a user computing device (104). The application server (101), the database server (102), and the user computing device (104) are typically communicatively coupled with each other via the communication network (103). In an embodiment, the application server (101) may communicate with the database server (102), and the user computing device (104) using one or more protocols such as, but not limited to, Hypertext Transfer Protocol (HTTP), Transmission Control Protocol/Internet Protocol (TCP/IP), Wireless Application Protocol (WAP), RF mesh, Bluetooth Low Energy (BLE), and the like, to communicate with one another.

In an embodiment, the database server (102) may refer to a computing device that may be configured to store the user content including user inputs and information of one or more user profiles. In an embodiment, the database server (102) may include a special purpose operating system specifically configured to perform one or more database operations on the user content. Examples of database operations may include, but are not limited to, Select, Insert, Update, and Delete. In an embodiment, the database server (102) may include hardware that may be configured to perform one or more predetermined operations. In an embodiment, the database server (102) may be realized through various technologies such as, but not limited to, Microsoft® SQL Server, Oracle®, IBM DB2®, Microsoft Access®, PostgreSQL®, MySQL®, SQLite®, distributed database technology and the like. In an embodiment, the database server (102) may be configured to utilize the application server (101) for storage and retrieval of data used for providing a networking platform for B2B interaction between one or more users.

A person with ordinary skills in art will understand that the scope of the disclosure is not limited to the database server (102) as a separate entity. In an embodiment, the functionalities of the database server (102) can be integrated into the application server (101) or into the user computing device (104).

In an embodiment, the application server (101) may refer to a computing device or a software framework hosting an application or a software service. In an embodiment, the application server (101) may be implemented to execute procedures such as, but not limited to, programs, routines, or scripts stored in one or more memories for supporting the hosted application or the software service. In an embodiment, the hosted application or the software service may be configured to perform one or more predetermined operations. The application server (101) may be realized through various types of application servers such as, but are not limited to, a Java application server, a .NET framework application server, a Base4 application server, a PHP framework application server, or any other application server framework.

In an embodiment, the application server (101) may be configured to utilize the database server (102) and the user computing device (104), in conjunction, for providing a networking platform for B2B interaction between one or more users. In an implementation, the application server (101) corresponds to the networking platform for enabling interaction between the one or more users by empowering effective collaboration and co-creation of ideas, product and innovation.

In an embodiment, the application server (101) may be configured to receive the content from one or more users. In an exemplary embodiment, the content corresponds to at least one of a video, a knowledge sharing article, a presentation, a post, a promotion, an advertisement, and an inquiry.

In an embodiment, the application server (101) may be configured to analyze one or more user profiles associated with the one or more users to identify relevancy of the received content based on the user input. In an embodiment, the user input may be indicative of user intent, user preferences, and user interests.

In an exemplary embodiment, the one or more users may include at least one of a consultant, a manufacturer, an innovator, an expert, a supplier, a vendor, or a service provider amongst other relevant profiles within the B2B space.

In another exemplary embodiment, the user input may include a selection of at least one of an industry type, a sub-industry type, an area of interest, categories, technologies, knowledge areas, and countries.

In an embodiment, the application server (101) may be configured to identify one or more relevant profiles from the one or more user profiles, associated with one or more users, based on the analysis.

In an embodiment, the application server (101) may be configured to share the received content with the one or more relevant profiles from the one or more users identified as one or more relevant users.

In an embodiment, the application server (101) may be configured to enable collaboration on the shared content amongst the one or more relevant users for co-creating content.

In an embodiment, the application server (101) may be configured to provide the created content to the one or more relevant users corresponding to the one or more relevant profiles.

In an embodiment, the communication network (103) may correspond to a communication medium through which the application server (101), the database server (102), and the user computing device (104) may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), Wireless Application Protocol (WAP), File Transfer Protocol (FTP), ZigBee, EDGE, infrared IR), IEEE 802.11, 802.16, 2G, 3G, 4G, 5G, 6G, 7G cellular communication protocols, and/or Bluetooth (BT) communication protocols. The communication network (103) may either be a dedicated network or a shared network. Further, the communication network (103) may include a variety of network devices, including routers, bridges, servers, computing devices, storage devices, and the like. The communication network (103) may include, but is not limited to, the Internet, intranet, a cloud network, a Wireless Fidelity (Wi-Fi) network, a Wireless Local Area Network (WLAN), a Local Area Network (LAN), a cable network, the wireless network, a telephone network (e.g., Analog, Digital, POTS, PSTN, ISDN, xDSL), a telephone line (POTS), a Metropolitan Area Network (MAN), an electronic positioning network, an X.25 network, an optical network (e.g., PON), a satellite network (e.g., VSAT), a packet-switched network, a circuit-switched network, a public network, a private network, and/or other wired or wireless communications network configured to carry data.

In an embodiment, the user computing device (104) may comprise of one or more processors and one or more memory. The one or more memories may include computer readable code that may be executable by one or more processors to perform predetermined operations. In an embodiment, the user computing device (104) may present a web user interface to transmit the training file and the testing file to the application server (102). Example web user interfaces presented on the one or more portable devices to display a portal visualizing user profile and relevant information, providing a networking platform for B2B interaction between one or more users. Examples of the user computing devices may include, but are not limited to, a personal computer, a laptop, a personal digital assistant (PDA), a mobile device, a tablet, or any other computing device.

The system (100) can be implemented using hardware, software, or a combination of both, which includes using where suitable, one or more computer programs, mobile applications, or “apps” by deploying either on-premises over the corresponding computing terminals or virtually over cloud infrastructure. The system (100) may include various micro-services or groups of independent computer programs which can act independently in collaboration with other micro-services. The system (100) may also interact with a third-party or external computer system. Internally, the system (100) may be the central processor of all requests for transactions by the various actors or users of the system. A critical attribute of the system (100) is that it can concurrently and instantly complete an online transaction by a system user in collaboration with other systems. In a specific embodiment, the system (100) is implemented for providing a networking platform for B2B interaction between one or more users.

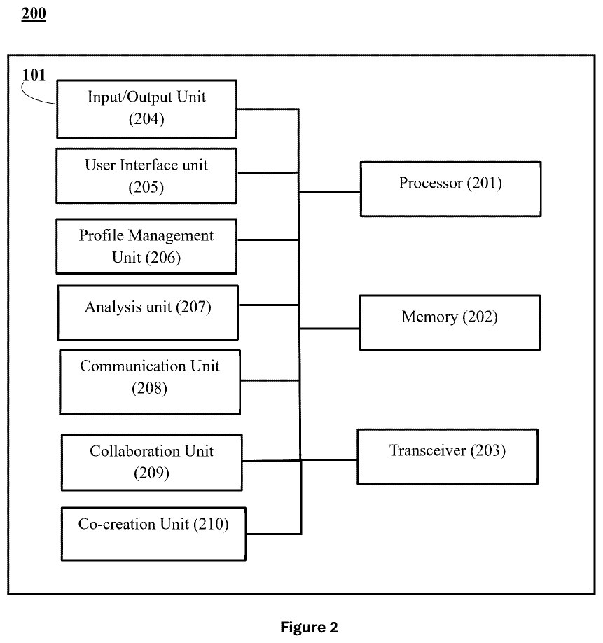

Now referring to FIG. 2, illustrates a block diagram (200) illustrating various components of an application server (101) configured to provide the networking platform for B2B interaction between the one or more users, in accordance with an embodiment of the present invention. FIG. 2 is explained in conjunction with elements from FIG. 1. In an embodiment, the application server (101) includes a processor (201), a memory (202), a transceiver (203), an input/output unit (204), a user interface unit (205), a profile management unit (206), an analysis unit (207), a communication unit (208), a collaboration unit (209), and a co-creation unit (210). The processor (201) may be communicatively coupled to the memory (202), the transceiver (203), the input/output unit (204), the user interface unit (205), the profile management unit (206), the analysis unit (207), the communication unit (208), the collaboration unit (209), and the co-creation unit (210). The transceiver (203) may be communicatively coupled to the communication network (104) of the system (100).

The processor (201) comprises suitable logic, circuitry, interfaces, and/or code that may be configured to execute a set of instructions stored in the memory (202), and may be implemented based on several processor technologies known in the art. The processor (201) works in coordination with the memory (202), the transceiver (203), the input/output unit (204), the user interface unit (205), the profile management unit (206), the analysis unit (207), the communication unit (208), the collaboration unit (209), and the co-creation unit (210) for enabling interaction between the one or more users. Examples of the processor (201) include, but not limited to, a standard microprocessor, microcontroller, central processing unit (CPU), an X86-based processor, a Reduced Instruction Set Computing (RISC) processor, an Application-Specific Integrated Circuit (ASIC) processor, and a Complex Instruction Set Computing (CISC) processor, distributed or cloud processing unit, state machines, logic circuitries, and/or any devices that manipulate signals based on operational instructions and/or other processing logic that accommodates the requirements of the present invention.

The memory (202) comprises suitable logic, circuitry, interfaces, and/or code that may be configured to store the set of instructions, which are executed by the processor (201). Preferably, the memory (202) is configured to store one or more programs, routines, or scripts that are executed in coordination with the processor (201). Additionally, the memory (202) may include any computer-readable medium or computer program product known in the art including, for example, volatile memory, such as static random-access memory (SRAM) and dynamic random-access memory (DRAM), and/or non-volatile memory, such as read-only memory (ROM), erasable programmable ROM, a Hard Disk Drive (HDD), flash memories, Secure Digital (SD) card, Solid State Disks (SSD), optical disks, magnetic tapes, memory cards, virtual memory and distributed cloud storage. The memory (202) may be removable, non-removable, or a combination thereof. Further, the memory (202) may include routines, programs, objects, components, data structures, etc., which perform particular tasks or implement particular abstract data types. The memory (202) may include programs or coded instructions that supplement the applications and functions of the system (100). In one embodiment, the memory (202), amongst other things, serves as a repository for storing data processed, received, and generated by one or more of the programs or the coded instructions. In yet another embodiment, the memory (202) may be managed under a federated structure that enables the adaptability and responsiveness of the application server (101).

The transceiver (203) comprises suitable logic, circuitry, interfaces, and/or code that may be configured to receive, process or transmit information, data or signals, which are stored by the memory (202) and executed by the processor (201). The transceiver (203) is preferably configured to receive, process or transmit, one or more programs, routines, or scripts that are executed in coordination with the processor (201). The transceiver (203) is preferably communicatively coupled to the communication network (103) of the system (100) for communicating all the information, data, signals, programs, routines or scripts through the network.

The transceiver (203) may implement one or more known technologies to support wired or wireless communication with the communication network (103). In an embodiment, the transceiver (203) may include but is not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. Also, the transceiver (203) may communicate via wireless communication with networks, such as the Internet, an Intranet and/or a wireless network, such as a cellular telephone network, a wireless local area network (LAN) and/or a metropolitan area network (MAN). Accordingly, the wireless communication may use any of a plurality of communication standards, protocols and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The input/output (I/O) unit (204) comprises suitable logic, circuitry, interfaces, and/or code that may be configured to receive or present information. The input/output unit (204) comprises various input and output devices that are configured to communicate with the processor (201). Examples of the input devices include but are not limited to, a keyboard, a mouse, a joystick, a touch screen, a microphone, a camera, and/or a docking station. Examples of the output devices include, but are not limited to, a display screen and/or a speaker. The I/O unit (204) may include a variety of software and hardware interfaces, for example, a web interface, a graphical user interface, and the like. The I/O unit (204) may allow the system (100) to interact with the user directly or through the user computing devices (104). Further, the I/O unit (204) may enable the system (100) to communicate with other computing devices, such as web servers and external data servers (not shown). The I/O unit (204) can facilitate multiple communications within a wide variety of networks and protocol types, including wired networks, for example, LAN, cable, etc., and wireless networks, such as WLAN, cellular, or satellite. The I/O unit (204) may include one or more ports for connecting a number of devices to one another or to another server. In one embodiment, the I/O unit (204) allows the application server (101) to be logically coupled to other user computing devices (104), some of which may be built in. Illustrative components include tablets, mobile phones, wireless devices, etc.

Further, the input/output (I/O) unit (204) may include a display module, an input module, and a communication module. The display module may present content to the user, the input module may allow the user to provide preferences, interests, and other relevant information, and the communication module may facilitate the exchange of data between the user's device and the platform, ensuring seamless interaction and content delivery.

Further, the user interface unit (205) may include the display module and the input module. The display module may present the content to the user and the input module may allow the user to provide preferences, interests, and other relevant information. Furthermore, the user interface unit (205) may include interfaces for various content formats such as text, image, video, and audio. These components work together to facilitate user interaction and improve collaboration and co-creation of the relevant content based on the user input.

Further, the profile management unit (206) may be responsible for creating and maintaining one or more user profiles associated with the one or more users based on the user input. Furthermore, the profile management unit (206) may include a profile creation module operating in coordination with the memory (202). The profile creation module may be responsible for generating the one or more user profiles based on the user input indicative of user intent, preferences, and interests. The memory (202) may securely store all user profiles and associated data, ensuring quick retrieval and efficient management of user information. These components work together to create, manage, and utilize user profiles for delivering personalized content for further collaboration and co-creation.

In an exemplary embodiment, the content based on the user input may include selections of industry type, sub-industry type, areas of interest, categories, technologies, knowledge areas, and countries. For instance, a user may indicate an interest in the Manufacturing industry, specifically in the sub-industries of Chemical Manufacturing.

Further, the analysis unit (207) may be configured to analyze the one or more user profiles associated with the one or more users to identify relevancy of the received content based on the user input indicative of user intent, user preferences, and user interests. In an embodiment, the user input may be utilized to create one or more user profiles associated with one or more users.

In an exemplary embodiment, the one or more user profiles may include detailed information on user's intent/interests, historical interactions, engagement metrics, industry types, sub-industry types, areas of interest, and professional.

In an embodiment, the analysis unit (207) may employ one or more algorithms or logics or machine learning techniques to analyze the one or more user profiles associated with the one or more users and user interactions to provide personalized content recommendations and collaboration opportunities. Furthermore, the analysis unit (207) may be configured to calculate a preference matching technique based on factors including keyword matching and user interest alignment. In an embodiment, the matching is done based on the user intent and the user preferences. For example, when the user sign-up on the platform, the one or more users select their areas of interest and the content they see on the platform (namely promotions, advertisements, etc.) are in line with their choice of selection, using the preference matching technique. Furthermore, the analysis unit (207) may be configured to generate a notification to the one or more users. In an embodiment, the notification includes relevant content and the predicted collaboration opportunities identified based on the matching of the user preferences.

In an exemplary embodiment, the preference matching technique may include software and/or algorithms to achieve the operations for processing, communicating, delivering, gathering, uploading, maintaining, and/or generally managing data, as described herein. Alternatively, such operations and techniques may be achieved by any suitable hardware, component, device, application specific integrated circuit (ASIC), additional software, field programmable gate array (FPGA), server, processor, algorithm, erasable programmable ROM (EPROM), electrically erasable programmable ROM (EEPROM), or any other suitable object that is operable to facilitate such operations.

Further, the communication unit (208) may be configured to share the received content with the one or more relevant profiles from the one or more users identified as one or more relevant users. Further, the communication unit (208) may be configured to identify similarity between content metadata and user profile data to determine preference matching for each piece of content relative to each user. Furthermore, the communication unit (208) may be configured to perform collaborative filtering to recommend co-creation of the content based on similarities between users'intent and preferences. In terms of content sharing, matching happens on the basis of user preference and intent. This helps to identify and deliver the most pertinent content to users based on their profiles and input.

Further, the collaboration module (209) may be configured to enable collaboration on the shared content amongst the one or more relevant users for co-creating content. Furthermore, the collaboration module (209) may be configured to enable the one or more users including at least one of the consultants, the manufacturer, the innovator, the expert, the supplier, the vendor, or the service provider amongst other relevant profiles within the B2B space, to collaborate over the shared content. Furthermore, the collaboration module (209) may include a chat interface for enabling collaboration among the one or more relevant profiles associated with the one or more relevant users. Furthermore, the collaboration module (209) may be configured to create a live session for discussing and enabling collaboration, discoverability, knowledge sharing on the shared content amongst the one or more relevant profiles associated with the one or more relevant users. Thus, the disclosed networking platform for B2B interaction may provide a cohesive network amongst the one or more user profiles associated with the one or more of users for co-creating, sharing the content, and discovering each other for sourcing, buying and collaboration opportunities.

In an exemplary embodiment, the system (100) may allow the user to create a profile by specifying their industry, sub-industry, and areas of interest. Posts made by the user become visible to their connections, while promotions may be targeted to the sub-industries selected by the user, ensuring that only those whose interests align with the promoter's sub-industry receive them, thereby guaranteeing intent. Further, the one or more users may send inquiries either as posts or promotions, and ads may be directed to selected sub-industries, enhancing the precision and relevance of the content delivered within the network.

Further, the co-creation module (210) may be configured to provide the created content as well as a co-created content to the one or more relevant users corresponding to the one or more relevant profiles. Furthermore, providing the created content may include the user interface for enabling searching of the created content. In an embodiment, the created content is categorized and tagged to enhance discoverability and relevance based on preference matching. The co-creation module (210) may be configured to provide the co-created content to the one or more relevant profiles associated with the one or more relevant users and displaying the co-created content on the user interface for further collaboration among the one or more relevant profiles associated with the one or more relevant users. Furthermore, the co-creation module (210) may deliver the content through different formats, including image, text, video, and audio output.

Further, the collaboration module (209) may be configured to send a weblink or host the live session on the disclosed networking platform. Further, the weblink may be sent to the one or more relevant profiles associated with the one or more relevant users to attend the live session. Additionally, sending the weblink may involve providing the created content or knowledge-sharing content to the one or more relevant profiles associated with the one or more relevant users. Moreover, weblink may facilitate displaying the created content or knowledge-sharing content on the user interface, thereby enabling further collaboration among the one or more relevant profiles associated with the one or more relevant users.

In operation, the system may function by first receiving the content as the user input indicative of user intent, preferences, and interests. This input is then processed through various modules, such as the profile management unit (206), the analysis unit (207) and communication unit (208) to identify the one or more relevant user profiles and match relevant content to these profiles. The collaboration unit (209) may enable collaboration on the shared content amongst the one or more relevant users for co-creating content. Additionally, the co-creation unit (210) may provide the co-created content to the one or more relevant users corresponding to the one or more relevant profiles.

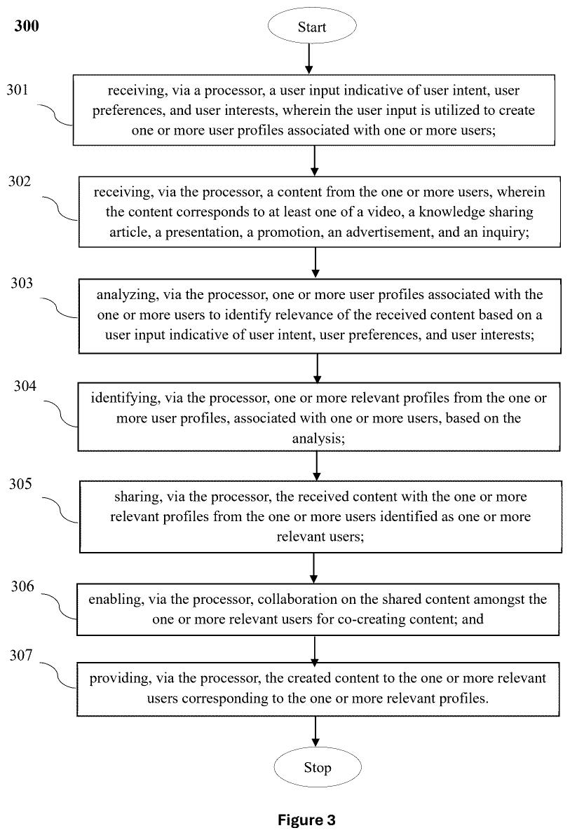

Now referring to FIG. 3, illustrates a flowchart describing a method (300) for providing the networking platform for B2B interaction between one or more users, in accordance with at least one embodiment. The flowchart is described in conjunction with FIG. 1 and FIG. 2. The method (300) starts at step (301) and proceeds to step (306).

In operation, the method (300) may involve a variety of steps for providing the networking platform for B2B interaction between the one or more users.

At step (301), the processor (201) may be configured to receive a user input indicative of user intent, user preferences, and user interests. The user input is utilized to create one or more user profiles associated with one or more users.

At step (302), the processor (201) may be configured to receive the content from the one or more users. In an embodiment, the content corresponds to at least one of the video, the knowledge sharing article, the presentation, the promotion, the post, the advertisement, and the inquiry.

At step (303), the processor (201) may be configured to analyze the one or more user profiles associated with the one or more users to identify relevance of the received content based on the user input. In an embodiment, the user input may be indicative of user intent, user preferences, and user interests.

At step (304), the processor (201) is configured to identify the one or more relevant profiles from the one or more user profiles, associated with one or more users based on analysis.

At step (305), the processor (201) is configured to share the received content with the one or more relevant profiles from the one or more users identified as one or more relevant users.

At step (306), the processor (201) is configured to enable collaboration on the shared content amongst the one or more relevant users for co-creating content.

At step (307), the processor (201) is configured to provide the created content to the one or more relevant users corresponding to the one or more relevant profiles.

Let us delve into a detailed example of the present disclosure.

Imagine the digital platform designed to provide personalized content experiences for professionals in various industries, such as an online networking platform for consultants, manufacturers, innovators, experts, and suppliers.

Users sign up for the platform and provide input about their intent, preferences, and interests. This input includes selections of industry types, sub-industry types, areas of interest, technologies, knowledge areas, and countries. The platform's processor utilizes this input to create detailed user profiles for each user.

A processor of the networking platform receives the content from the one or more users based on the user input.

Users submit content to the platform, which may include promotions, advertisements, or queries related to their professional activities and interests.

Using machine learning/logic/algorithm techniques, the processor analyses and identifies relevant profiles for each submitted content based on the similarity between the content features and the characteristics of user profiles. This ensures that the content is directed to the most suitable users.

The platform shares the received content to the relevant users corresponding to the identified profiles for further collaboration and co-creation. Thus, the content is tailored based on the user input and analyzed profiles, ensuring it aligns with each user's professional interests and preferences.

The platform displays the content on the user interface in various formats, including images, text, videos, or audio. Users can access the content through personalized feeds, highlighting the most relevant content based on their profiles.

In a practical scenario, consider the networking platform designed for professionals in the manufacturing industry, where users such as consultants, manufacturers, innovators, experts, vendors and suppliers can interact and collaborate. For instance, a manufacturer posts a video seeking innovative solutions for reducing production waste. Upon receiving the video, the system analyzes user profiles based on their industry type, areas of interest, and historical interactions to identify relevant users who can contribute valuable insights.

Using preference matching technique, the system identifies matching keywords and aligning user interests. It identifies profiles of a sustainability consultant, an innovator specializing in waste reduction technologies, an environmental expert, and a supplier of eco-friendly materials. These users are notified and invited to collaborate on the video.

The platform's chat interface and live session capabilities facilitate real-time discussion among the identified users. During these interactions, they brainstorm and develop a prototype solution for reducing production waste. The expert provides scientific insights, the innovator shares technological approaches, the consultant offers strategic recommendations, and the supplier suggests materials.

The co-created solution is then uploaded to the platform, categorized, and tagged for easy discoverability. The manufacturer, along with other users, can search for and access this content in various formats, such as text, images, videos, and audio. This fosters a collaborative ecosystem where users can leverage shared expertise to drive innovation and efficiency.

As a result, the manufacturer gains access to cutting-edge solutions, reduces time spent on offline networking, and benefits from targeted, relevant collaboration. The platform's data analytics further generate actionable insights, highlighting trends in waste reduction, user engagement metrics, and opportunities for further innovation. This process enhances the overall quality of interactions and user engagement, creating a cohesive network of professionals dedicated to advancing the manufacturing industry.

### Working Example

Let's envision a digital platform called “ABC” designed to connect professionals in various industries, including consultants, manufacturers, innovators, experts, and suppliers. The platform employs the system described in the claims to share content to the relevant users for collaboration and co-creation.

John explores “ABC” website and learns about its mission to empower professionals and foster collaboration and innovation. Intrigued by the platform's promise, he decides to sign up.

Upon registration, John fills out his profile, highlighting his expertise in sustainable materials and interest in eco-friendly packaging solutions. He selects industry types, sub-industries, and areas of interest relevant to her field.

Through the “ABC” platform, John connects with fellow consultants, manufacturers, innovators, experts, and suppliers. He joins discussions on sustainable packaging techniques and shares her own insights.

John uploads a knowledge-sharing article on the latest trends in biodegradable packaging. The platform analyzes user profiles to identify relevant users, such as manufacturers and suppliers interested in sustainable materials. These users receive notifications about Megan's article, prompting them to engage with the content.

Tom, a manufacturer looking for eco-friendly packaging for his consumer goods, finds John's article highly relevant. He uploads a presentation detailing his requirements for sustainable packaging. The platform analyzes Tom's profile and shares the presentation with relevant experts, including John.

John, along with an innovator specializing in biodegradable packaging technology and an environmental scientist, receives Tom's presentation. They initiate a chat conversation using the platform's interface to discuss potential solutions.

The platform facilitates the live session for further collaboration. John, the innovator, and the environmental scientist brainstorm ideas, leveraging each other's expertise. They develop a prototype for Tom's sustainable packaging needs.

The co-created prototype is uploaded to the platform. It is categorized and tagged for enhanced discoverability.

Through the “ABC” platform, John not only expands his network by collaborating and co-creating with industry peers but also stays updated on the latest manufacturing trends and opportunities. The platform serves as a valuable resource for him to grow his business and foster meaningful industry relationships.

A person skilled in the art will understand that the scope of the disclosure is not limited to scenarios based on the aforementioned factors and using the aforementioned techniques and that the examples provided do not limit the scope of the disclosure.

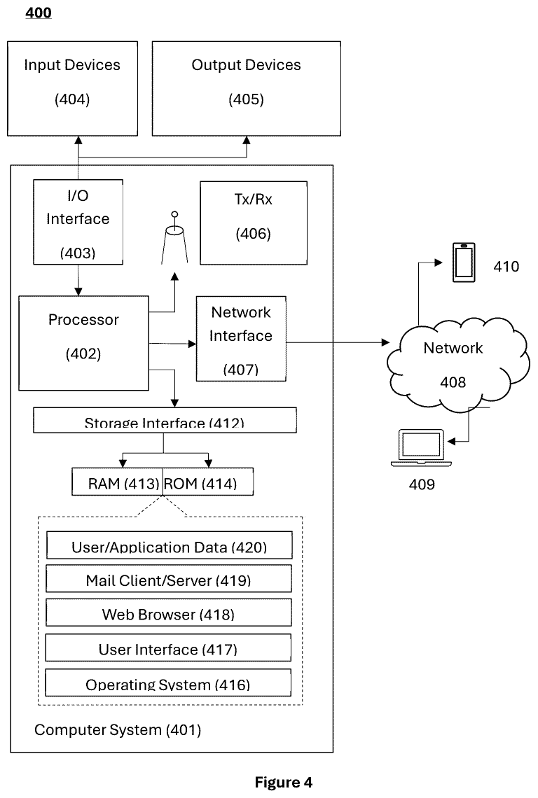

Now referring to FIG. 4, illustrates a block diagram of an exemplary computer system (401) for implementing embodiments consistent with the present disclosure.

Variations of computer system (401) may be used for providing a networking platform for B2B interaction between one or more users. The computer system (401) may comprise a central processing unit (“CPU” or “processor”) (402). The processor (402) may comprise at least one data processor for executing program components for executing user-or system-generated requests. The user may include a person, a person using a device such as such as those included in this disclosure, or such a device itself. Additionally, the processor (402) may include specialized processing units such as integrated system (bus) controllers, memory management control units, floating point units, graphics processing units, digital signal processing units, or the like. In various implementations the processor (402) may include a microprocessor, such as AMD Athlon, Duron or Opteron, ARM's application, embedded or secure processors, IBM PowerPC, Intel's Core, Itanium, Xeon, Celeron or other line of processors, for example. Accordingly, the processor (402) may be implemented using mainframe, distributed processor, multi-core, parallel, grid, or other architectures. Some embodiments may utilize embedded technologies like application-specific integrated circuits (ASICs), digital signal processors (DSPs), or Field Programmable Gate Arrays (FPGAs), for example.

Processor (402) may be disposed in communication with one or more input/output (I/O) devices via I/O interface (403). Accordingly, the I/O interface (403) may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMAX, or the like, for example.

Using the I/O interface (403), the computer system (401) may communicate with one or more I/O devices. For example, the input device (404) may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, or visors, for example. Likewise, an output device (405) may be the user's smartphone, tablet, cell phone, laptop, printer, fax machine, video display (e.g., cathode ray tube (CRT), liquid crystal display (LCD), light-emitting diode (LED), plasma, or the like), or audio speaker, for example. In some embodiments, a transceiver (406) may be disposed in connection with the processor (402). The transceiver (406) may facilitate various types of wireless transmission or reception. For example, the transceiver (406) may include an antenna operatively connected to a transceiver chip (example devices include the Texas Instruments® WiLink WL1283, Broadcom® BCM4750IUB8, Infineon Technologies® X-Gold 618-PMB9800, or the like), providing IEEE 802.11a/b/g/n, Bluetooth, FM, global positioning system (GPS), and/or 2G/3G/5G/6G HSDPA/HSUPA communications, for example.

In some embodiments, the processor (402) may be disposed in communication with a communication network (408) via a network interface (407). The network interface (407) is adapted to communicate with the communication network (408). The network interface, coupled to the processor may be configured to facilitate communication between the system and one or more external devices or networks. The network interface (407) may employ connection protocols including, without limitation, direct connect, Ethernet (e.g., twisted pair 10/100/1000 Base T), transmission control protocol/internet protocol (TCP/IP), token ring, or IEEE 802.11a/b/g/n/x, for example. The communication network (408) may include, without limitation, a direct interconnection, local area network (LAN), wide area network (WAN), wireless network (e.g., using Wireless Application Protocol), or the Internet, for example. Using the network interface (407) and the communication network (408), the computer system (401) may communicate with devices such as shown as a laptop (409) or a mobile/cellular phone (410). Other exemplary devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system (401) may itself embody one or more of these devices.

In some embodiments, the processor (402) may be disposed in communication with one or more memory devices (e.g., RAM 413, ROM 414, etc.) via a storage interface (412). The storage interface (412) may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, or solid-state drives, for example.

The memory devices may store a collection of program or database components, including, without limitation, an operating system (416), user interface application (417), web browser (418), mail client/server (419), user/application data (420) (e.g., any data variables or data records discussed in this disclosure) for example. The operating system (416) may facilitate resource management and operation of the computer system (401). Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like.

The user interface (417) is for facilitating the display, execution, interaction, manipulation, or operation of program components through textual or graphical facilities. For example, user interfaces may provide computer interaction interface elements on a display system operatively connected to the computer system (401), such as cursors, icons, check boxes, menus, scrollers, windows, or widgets, for example. Graphical user interfaces (GUIs) may be employed, including, without limitation, Apple Macintosh operating systems'Aqua, IBM OS/2, Microsoft Windows (e.g., Aero, Metro, etc.), Unix X-Windows, or web interface libraries (e.g., ActiveX, Java, JavaScript, AJAX, HTML, Adobe Flash, etc.), for example.

In some embodiments, the computer system (401) may implement a web browser (418) stored program component. The web browser (418) may be a hypertext viewing application, such as Microsoft Internet Explorer, Google Chrome, Mozilla Firefox, Apple Safari, or Microsoft Edge, for example. Secure web browsing may be provided using HTTPS (secure hypertext transport protocol), secure sockets layer (SSL), Transport Layer Security (TLS), or the like. Web browsers may utilize facilities such as AJAX, DHTML, Adobe Flash, JavaScript, Java, or application programming interfaces (APIs), for example. In some embodiments the computer system (401) may implement a mail client/server (419) stored program component. The mail server (419) may be an Internet mail server such as Microsoft Exchange, or the like. The mail server may utilize facilities such as ASP, ActiveX, ANSI C++/C #, Microsoft . NET, CGI scripts, Java, JavaScript, PERL, PHP, Python, or WebObjects, for example. The mail server (419) may utilize communication protocols such as internet message access protocol (IMAP), messaging application programming interface (MAPI), Microsoft Exchange, post office protocol (POP), simple mail transfer protocol (SMTP), or the like. In some embodiments, the computer system (401) may implement a mail client (420) stored program component. The mail client (520) may be a mail viewing application, such as Apple Mail, Microsoft Entourage, Microsoft Outlook, or Mozilla Thunderbird.

In some embodiments, the computer system (401) may store user/application data (421), such as the data, variables, records, or the like as described in this disclosure. Such databases may be implemented as fault-tolerant, relational, scalable, secure databases such as Oracle or Sybase, for example. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Various embodiments of the disclosure encompass numerous advantages including a method for providing a networking platform for B2B interaction between one or more users. The disclosed method and system have several technical advantages, but not limited to the following:
Efficient Stakeholder Connection: The platform provides an efficient and effective means of connecting diverse stakeholders, ensuring seamless communication and collaboration across various sectors.
Time and Convenience: The platform significantly reduces the time and inconvenience associated with offline networking. By enabling digital interactions, stakeholders can connect and collaborate more easily and efficiently, overcoming geographical and logistical barriers.
Sharp Targeting: The system provides sharp targeting capabilities, allowing stakeholders to connect with the most relevant and suitable partners derived from detailed profile analyses and user interactions.
Collaborative Ecosystem: It creates a collaborative ecosystem that fosters innovation and value creation. By enabling co-creation of content and facilitating real-time collaboration through chat interfaces and live sessions, the platform encourages active participation and knowledge sharing among its users.
Personalized Content Delivery: By utilizing user input to create detailed profiles and employing machine learning techniques for profile identification, the method ensures that content is tailored to each user's specific preferences and interests.
Interactive Collaboration Tools: Features such as chat interfaces and live sessions enable real-time discussions and content co-creation, enhancing user engagement and collective problem-solving.
Enhanced Discoverability: Co-created content is categorized and tagged to improve discoverability through a user-friendly search interface, ensuring users can easily find and access relevant content.
Broad User Base Support: The system accommodates a wide range of user types, fostering diverse interactions and knowledge sharing across various professional domains.

In summary, these technical advantages solve the technical problem by providing an enhanced networking platform designed to facilitate seamless B2B interaction and collaboration among various stakeholders in the business value chain. Additionally, these advantages contribute to targeted content sharing, ensuring that users connect with the most suitable partners, thereby fostering effective collaboration and co-creation for a better future.

Furthermore, the invention involves a non-trivial combination of technologies and methodologies that provide a technical solution for a technical problem. While individual components like processors, databases, encryption, authorization and authentication are well-known in the field of computer science, their integration into a comprehensive system for providing the networking platform for B2B interaction between one or more users, brings about an improvement and technical advancement in the field of providing the networking platform for B2B interaction between one or more users.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like. The claims can encompass embodiments for hardware and software, or a combination thereof. While the present disclosure has been described with reference to certain embodiments, it will be understood by those skilled in the art that various changes may be made, and equivalents may be substituted without departing from the scope of the present disclosure. In addition, many modifications may be made to adapt a particular situation or material to the teachings of the present disclosure without departing from its scope. Therefore, it is intended that the present disclosure is not limited to the particular embodiment disclosed, but that the present disclosure will include all embodiments falling within the scope of the appended claims.

What is claimed is:

1. A system (100) for providing a networking platform for B2B interaction between one or more
users, the system (100) comprises:
a processor (201); and
a memory (202) communicatively coupled to the processor (201), wherein the memory (202) stores processor executable instructions, which, on execution, causes the processor (201) to:
receive a content from the one or more users, wherein the content corresponds to at least one of a video, a knowledge sharing article, a presentation, a promotion, an advertisement, and an inquiry;
analyze one or more user profiles associated with the one or more users to identify relevancy of the received content based on a user input indicative of user intent, user preferences, and user interests;
identify one or more relevant profiles from the one or more user profiles, associated with one or more users, based on the analysis;
share the received content with the one or more relevant profiles associated with the one or more users identified as one or more relevant users;
enable collaboration on the shared content amongst the one or more relevant users for co-creating content; and
providing the created content to the one or more relevant users corresponding to the one or more relevant profiles.

2. The system (100) as claimed in claim 1, wherein analyzing the one or more user profiles
associated with the one or more users to identify relevancy of the received content based on the user input comprises:
employing one or more machine learning techniques to analyze the one or more user profiles associated with the one or more users and user interactions to provide personalized content recommendations and collaboration opportunities;
calculating a preference matching technique based on factors comprising keyword matching and user interest alignment, wherein the matching is done based on the user intent and user preferences; and
generating a notification to the one or more users, wherein the notification comprises relevant content and the collaboration opportunities identified based on the matching of the user preferences.

3. The system (100) as claimed in claim 1, wherein identifying the one or more relevant profiles
from the one or more user profiles, associated with the one or more users, comprises:
identifying similarity between content metadata and user profile data to determine preference matching for each piece of content relative to each user; and
performing collaborative filtering to recommend co-creation of the content based on similarities between users'intent and preferences.

4. The system (100) as claimed in claim 1, wherein the one or more users comprises at least one of a consultant, a manufacturer, an innovator, an expert, a supplier, a vendor or a service provider amongst other relevant profiles within the B2B space.

5. The system (100) as claimed in claim 1, wherein the user input comprises a selection of at least one of an industry type, a sub-industry type, an area of interest, categories, technologies, knowledge areas, and countries.

6. The system (100) as claimed in claim 1, wherein the one or more user profiles comprises detailed information on user intent/interests, historical interactions, engagement metrics, industry types, sub-industry types, areas of interest, and professional.

7. The system (100) as claimed in claim 1, wherein the networking platform provides a cohesive network amongst the one or more user profiles associated with the one or more of users for co-creating, sharing the content, and discovering each other for sourcing, buying and collaboration opportunities.

8. The system (100) as claimed in claim 1, wherein providing the created content comprises:
a user interface to enable searching of the created content, wherein the created content is categorized and tagged to enhance discoverability and relevance; and
delivering the content through different formats, including image, text, video, and audio output.

9. The system (100) as claimed in claim 1, comprises a chat interface for enabling collaboration among the one or more relevant profiles associated with the one or more relevant users.

10. The system (100) as claimed in claim 1, comprises creating a live session for discussing and enabling collaboration, discoverability, knowledge sharing on the shared content amongst the one or more relevant profiles associated with the one or more relevant users.

11. The system (100) as claimed in claim 10, comprises sending a weblink/hosting the live session
on the networking platform to the one or more relevant profiles associated with the one or more relevant users to attend the live session, comprise:
providing the created/knowledge sharing content to the one or more relevant profiles associated with the one or more relevant users; and
displaying the created/knowledge sharing content on the user interface for further collaboration among the one or more relevant profiles associated with the one or more relevant users.

12. A method (300) for providing a networking platform for B2B interaction between one or more
users, the method (300) comprises:
receiving (301), via a processor (201), a user input indicative of user intent, user preferences, and user interests, wherein the user input is utilized to create one or more user profiles associated with one or more users;
receiving (302), via the processor, a content from the one or more users, wherein the content corresponds to at least one of a video, a knowledge sharing article, a presentation, a promotion, an advertisement, and an inquiry;
analyzing (303), via the processor, the one or more user profiles associated with the one or more users to identify relevancy of the received content based on the user input indicative of the user intent, the user preferences, and the user interests;
identifying (304), via the processor, one or more relevant profiles from the one or more user profiles, associated with one or more users, based on the analysis;
sharing (305), via the processor, the received content with the one or more relevant profiles associated with the one or more users identified as one or more relevant users;
enabling (306), via the processor, collaboration on the shared content amongst the one or more relevant users for co-creating content; and
providing (307), via the processor, the created content to the one or more relevant users corresponding to the one or more relevant profiles.

13. A non-transitory computer-readable storage medium having stored thereon, a set of computer-executable
instructions causing a computer comprising one or more processors to perform steps comprising:
receiving a user input indicative of user intent, user preferences, and user interests, wherein the user input is utilized to create one or more user profiles associated with one or more users;
receiving a content from the one or more users, wherein the content corresponds to at least one of a video, a knowledge sharing article, a presentation, a promotion, an advertisement, and an inquiry;
analyzing the one or more user profiles associated with the one or more users to identify relevancy of the received content based on the user input indicative of the user intent, the user preferences, and the user interests;
identifying one or more relevant profiles from the one or more user profiles, associated with one or more users, based on the analysis;
sharing the received content with the one or more relevant profiles associated with the one or more users identified as one or more relevant users;
enabling collaboration on the shared content amongst the one or more relevant users for co-creating content; and
providing the created content to the one or more relevant users corresponding to the one or more relevant profiles.
